(19) United States
(12) Patent Application Publication
(10) Pub. No.: US 2012/0212321 A1
(43) Pub. Date: Aug. 23, 2012

(54) SYSTEM AND METHOD FOR MANAGING ACCESS TO AND TRACKING A PLURALITY OF CARTS

(75) Inventors: Kurt Keener, Gahanna, OH (US); Eric Webb, Vancouver, WA (US); Todd Macy, Columbus, OH (US)

(73) Assignee: CAPSA SOLUTIONS LLC, Columbus, OH (US)

(21) Appl. No.: 13/029,914

(22) Filed: Feb. 17, 2011

(51) Int. Cl. G08B 29/00

(52) U.S. Cl. 340/5.8

(57) ABSTRACT

A system and method for managing access to a plurality of carts. A plurality of users may be created in a database, each user having unique identifying information. Users may be grouped into user groups when having similar attributes. Each cart may have an entry in the database with associated attributes. Carts may be grouped into cart groups for carts having similar attributes. Users may be given access to cart either individually, through a user group that has access to the cart, by given access to an entire group of carts, or through a user group that has access to an entire group of carts. The various associations can be interwoven to provide groups and sub-groups for managing applications where multiple users must interact with multiple carts. The carts can store access logs which may be communicated in real time to a computing device or may be stored locally at the cart for later access by an administrator.

### CROSS-REFERENCE TO RELATED APPLICATIONS

This application does not claim priority to any co-pending applications.

### TECHNICAL FIELD

Embodiments generally relate to a system and method for managing access to and tracking a plurality of carts and associated user activity.

### BACKGROUND OF THE ART

Carts and specifically medical carts are used in a number of different health care settings, including but not limited to: acute care, long term care, operating/surgical facilities, emergency rooms, and physician/dentist offices. In many applications, these carts are used to store, transport, and dispense medical supplies for the given health care setting. In some cases, these medical supplies can include medications/drugs and often times may include narcotics. As a way of preventing the misuse or abuse of a variety of medications, it may be desirable to limit the access of certain medical personnel to a specific cart or group of cart(s) and even limit the access of certain medical personnel to only a specific drawer or cabinet within a cart.

Further, it may be desirable to track the various interactions of medical personnel with the medical carts. This ‘tracking’ process can allow a variety of different types of data about the carts (‘cart data’) to be used to validate that the intended personnel were accessing their intended carts during the appropriate days/times. Due to the number of employees and the size of some medical facilities, establishing appropriate controls over all of the medical personnel and their access to the various carts can present a number of difficulties for the administrator at the particular medical facility.

Carts are also used to store any number of other items including but not limited to: tools, cash, parts, electrical supplies, valuable stones, customer information, medical supplies, pharmaceuticals, and sensitive documents. It is therefore desirable to control access to any of these items and track the use of any carts containing them.

### SUMMARY OF THE EXEMPLARY EMBODIMENTS

Exemplary embodiments include systems and methods for establishing users, user groups, carts, and cart groups which can have any number of varying attributes related to access, location, intended use, and actual use. With an exemplary embodiment, large numbers of carts and users can be efficiently managed by grouping and sub-grouping carts and users having similar attributes.

Each cart may remain locked until access is attempted. An identification process may be used to determine if the person should be permitted access. This process may compare the unique identification numbers/codes for the permitted users with the person attempting access. The carts can store access logs which may be communicated in real time to a computing device or may be stored locally at the cart for later access by an administrator. The access logs may contain a plurality of different types of information regarding the access or attempted access of the cart. The access logs may be sent in real-time to a computing device. Alternatively, the logs may be stored locally at the cart and sent at a recurring day/time to the computing device or when demanded manually by an administrator through a user interface.

The embodiments herein permit large numbers of carts and users with complicated access provisions to be efficiently and securely maintained.

The foregoing and other features and advantages of the present invention will be apparent from the following more detailed description of the particular embodiments, as illustrated in the accompanying drawings.

### BRIEF DESCRIPTION OF THE DRAWINGS

A better understanding of an exemplary embodiment will be obtained from a reading of the following detailed description and the accompanying drawings wherein identical reference characters refer to identical parts and in which:

FIG. 1 is an illustration of one application for an exemplary embodiment of the invention.

FIG. 2 is a screen shot for the home page of an exemplary user interface for practicing an exemplary embodiment of the invention.

FIG. 3 is a screen shot of an exemplary user interface for managing the user groups.

FIG. 4 is a screen shot of an exemplary user interface for managing the cart groups.

FIG. 5 is a screen shot of an exemplary user interface for assigning users to user groups.

FIG. 6 is a screen shot of an exemplary user interface for assigning carts to cart groups.

FIG. 7 is a screen shot of an exemplary user interface for assigning users, user groups, and carts to cart groups.

FIG. 8 is a screen shot of an exemplary user interface for editing user attributes and identifying information.

FIG. 9 is a screen shot of an exemplary user interface for editing cart attributes.

FIG. 10 is an illustration of another application for an exemplary embodiment of the invention.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The embodiments herein are described in references to a plurality of ‘carts.’ As used herein, the term ‘cart’ refers to any one of the following: medical carts, tool carts, cash register/point of sale carts, and any other type of cart used to store items where it is desirable to limit the access to the stored items. The term ‘carts’ includes storage devices which are both mobile and immobile. While some embodiments may be described with respect to medical carts or pharmaceutical applications, it should be specifically noted that the invention is not limited to such applications.

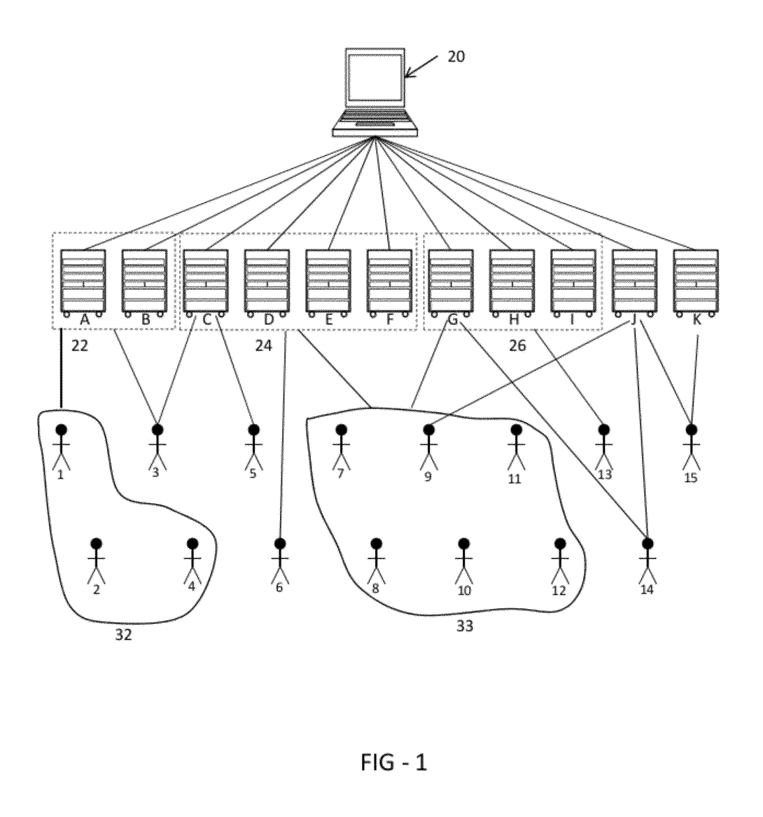

FIG. 1 is an illustration of one application for an exemplary embodiment of the invention. In this embodiment, a computing device 20 is in electrical communication with a plurality of carts A-K. The computing device 20 can be any type of electronic device with a processor that is capable of running software, receiving data, and sending data. In an exemplary embodiment, the computing device 20 would be a personal computing device, including but not limited to: desktop computer, laptop computer, smart phone, or tablet computer. In some embodiments, the computing device 20 may be a local server having a network connection so that the user interface may be accessed and operated remotely. Preferably, both the computing device 20 and the carts A-K contain a means for transmitting and receiving electronic data, which may be used to establish the electrical communication between the computing device 20 and the carts A-K. The electrical communication between the computing device 20 and the carts A-K may take place over a wired or wireless network. As will be discussed further below, the electrical communication between the computing device 20 and the carts A-K may occur continuously, at a regularly occurring day/time, or when manually triggered by an administrator.

Each cart may preferably contain a software processor, a local electronic storage device (such as a hard drive or flash drive), and a device for transmitting/receiving electronic data (wireless/wired network card and/or Ethernet connection). Each cart also preferably contains a plurality of drawers or cabinets for housing medical devices. At least some of the drawers or cabinets in the cart may be locked so that only a user given access to the cart may unlock and/or open the drawers or cabinets. Once a user is assigned (to have access) to the cart and/or particular drawers using the system herein, they may be given a key for access to the cart. The key can be, but is not limited to, any of the following: mechanical key, RFID tag, magnetic strip card, fingerprint ID, or numerical code. Thus, each cart may contain a corresponding device for evaluating the key, such as a: mechanical lock, RFID reader, magnetic strip reader, fingerprint reader, or numerical keypad. Each time a user accesses a cart, the information regarding who accessed the cart and when did this access take place can be stored on a local storage device at the cart, for later access by an administrator. If using wireless communication between the carts and computing device 20, this information could also be sent in real-time from the carts to the computing device 20.

In this particular embodiment and application shown in FIG. 1, the carts A-K contain three cart groups 22, 24, and 26. For the purposes of explanation below, cart group 22 will be referred to as the pediatric carts 22 and cart group 24 will be referred to as the geriatric carts 24. Also in this application, several separate users 1-15 are shown, each having varying levels of access to the carts A-K. Similar to the carts, the users 1-15 also contain two user groups 32 and 33. Again, for the purposes of explanation below, user group 32 will be referred to as the pediatric nurses 32 and user group 33 will be referred to as the geriatric nurses 33.

Here, the pediatric nurses group 32 contains user 1, user 2, and user 4 and are given access only to the pediatric carts 22 (cart A and cart B). The geriatric nurses group 33 contains users 7-12, and are given access to the geriatric carts 24 (carts C-F) and the individual cart G. User 3 is given access to the pediatric carts 22 and cart C. User 5 is given access only to cart C. User 6 is given access to the geriatric carts 24. User 9, although a member of the geriatric nurses group 33 (and thus already given access to the geriatric carts 24), is also given access to cart J. User 13 is given access to the cart group 26 (which includes carts G-I). User 14 is given access to cart G and cart J. User 15 is given access to cart J and cart K.

As can be readily observed from this figure, the exemplary embodiments herein not only permit groups to have access to carts but also for individual users within the group to have access to additional carts as well. For example, user 9 has access to the geriatric carts 24 and individual cart G (by being a member of the geriatric nurses 33) as well as cart J. Further, groups of users may have access to groups of carts in addition to individual carts. For example, the members of the geriatric nurses 33 have access to the geriatric carts 24 as well as the individual cart G.

The following figures provide screenshots of an exemplary user interface that may be ran by the computing device 20. The particular user interface chosen may run only on a local application or may run on a web-based application. An exemplary embodiment may use a web-based application where an internet connection can be established with the computing device 20 so that the user interface and associated software can be accessed remotely, through the internet connection of the computing device 20.

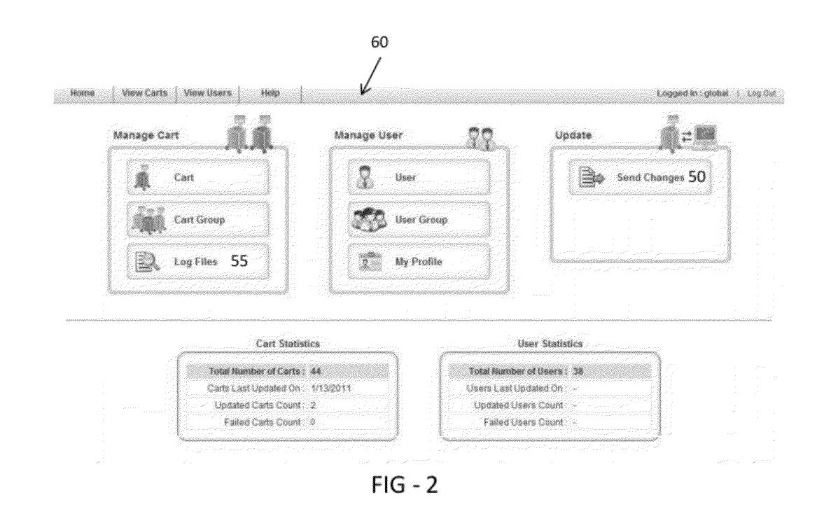

FIG. 2 is a screen shot for the home page of an exemplary user interface for practicing an exemplary embodiment of the invention. This page can be used as a primary navigation point through the various steps of an exemplary embodiment. A navigation bar 60 may be placed at the top of each page of the user interface, so that the user can quickly return to this home page from any other page in the user interface. Also, commonly used functions like ‘View Carts’ and ‘View Users’ can be placed in the navigation bar 60 as well. Further common features such as ‘Help’ and ‘Log Out’ can also be accessed from the navigation bar 60.

A number of steps can be performed under the ‘Manage Cart’ Heading including accessing cart information, cart group information (see FIG. 4), or the log files 55 for each cart or group of carts. The log files 55 may contain a multitude of information, including but not limited to each instance that each cart was accessed and all of the accompanying data to the cart's access. For instance, each time a cart is accessed, the cart may record: when a drawer was opened, when the drawer was closed, who accessed the cart, when the cart has been moved, which drawer was opened, and when has the cart been re-stocked with supplies.

Accelerometers can be placed within the carts to determine when they have been moved. These accelerometers can also be used to provide automated re-locking features where a cart will automatically re-lock itself after a drawer has been accessed and the cart has not been moved for a certain period of time. All of this data may be recorded in the log files 55 for each cart.

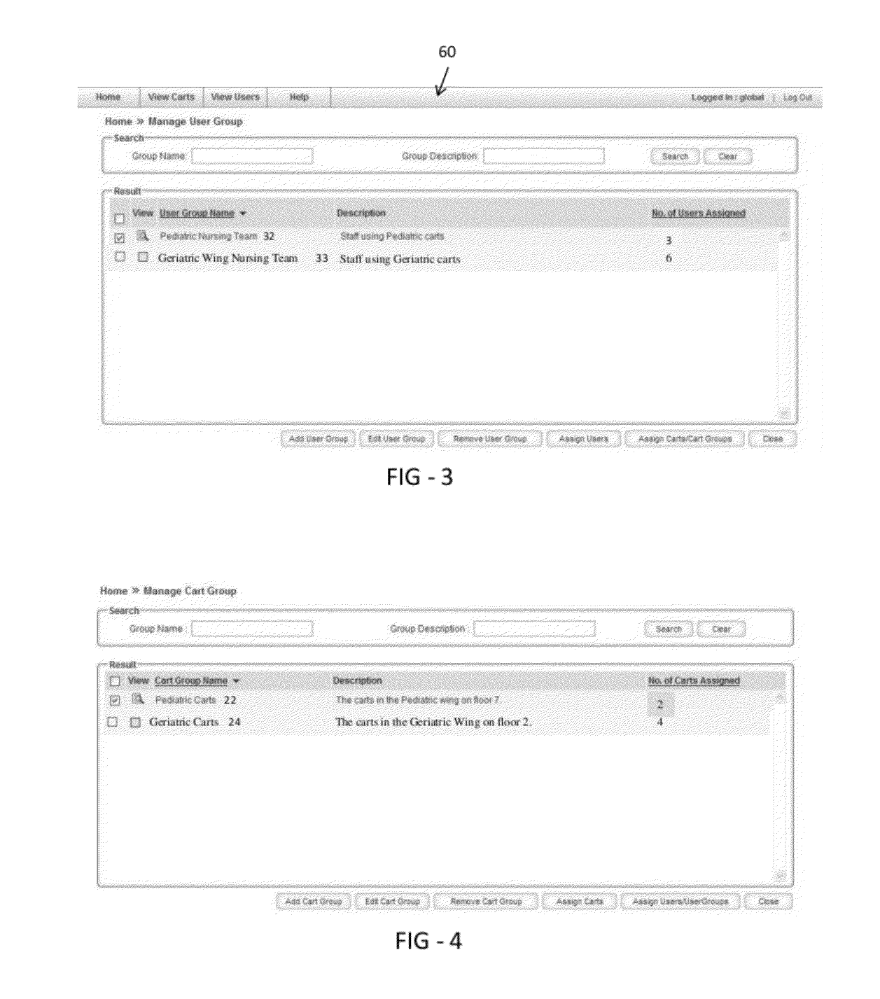

A number of steps can be performed under the ‘Manage User’ Heading including accessing user information, user group information (see FIG. 3), or the profile information for the user currently logged into the user interface. Under the ‘Update’ heading is a function for Send Changes 50. Using this function, a user can make any number of changes to users, user groups, carts, and cart groups and delay the actual updating of the user interface and cart software until the function Send Changes 50 has been run. This provides a number of benefits to the user, most notably that they can update their software without interrupting the current operations of the medical facility. An administrator may choose to update the software during the typical workday, but delay the application of the updates until after-hours or between shift changes so that there is only a minimal impact on the operations of the facility.

FIG. 3 is a screen shot of an exemplary user interface for managing the user groups. This portion of the user interface may be accessed by selecting ‘User Group’ under the ‘Manage User’ heading of the home page. The navigation bar 60 may be placed on this page, similar to the home page. As the navigation bar 60 can be placed on any page of the user interface, it will not be shown further. A searching function may be provided so that the user can search for a particular group based on the Group Name or Group Description. In this particular embodiment, the two user groups are shown as the Pediatric Nursing Team 32 and the Geriatric Wing Nursing Team 33. A description of each group along with the number of users assigned may be provided in a spreadsheet format. Additional user groups may be added by selecting ‘Add User Group.’ The existing groups may have their attributes edited by selecting ‘Edit User Group.’ An existing group may be deleted by selecting ‘Remove User Group.’ Users may be assigned/removed from groups by selecting ‘Assign Users.’ Access to carts or cart groups may be arranged by selecting ‘Assign Carts/Cart Groups.’ Thus, the interface shown in FIG. 3 may be used to enter/create and modify user group data.

FIG. 4 is a screen shot of an exemplary user interface for managing the cart groups. This portion of the user interface may be accessed by selecting ‘Cart Group’ under the ‘Manage Cart’ heading of the home page. A searching function may be provided on this page so that a user can search for a particular cart group based on the Group Name or Group Description. For this embodiment in particular, the two cart groups are shown as the Pediatric Carts 22 and the Geriatric Carts 24. A description of each group along with the number of carts assigned may be provided in a spreadsheet format. Additional cart groups may be added by selecting ‘Add Cart Group.’ The existing groups may have their attributes edited by selecting ‘Edit Cart Group.’ An existing group may be deleted by selecting ‘Remove Cart Group.’ Carts may be assigned/removed from cart groups by selecting ‘Assign Carts.’ User and/or user group access to cart groups may be arranged by selecting ‘Assign Carts/Cart Groups.’ Thus, the interface shown in FIG. 4 may be used to enter/create and modify cart group data.

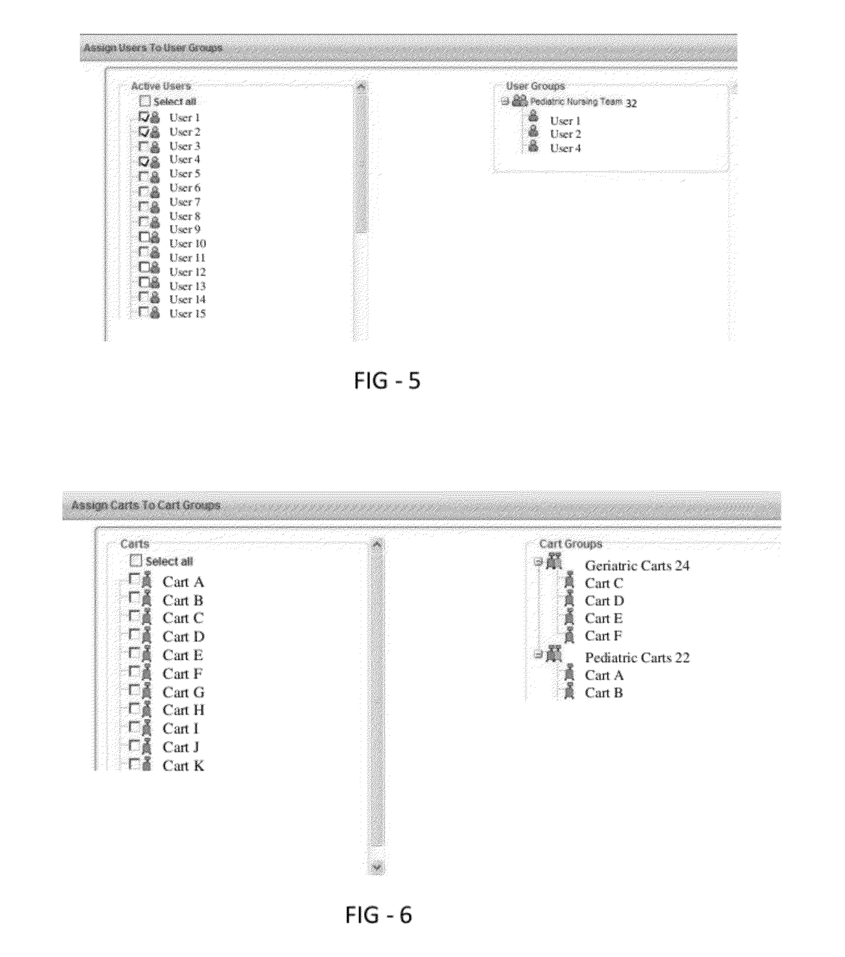

FIG. 5 is a screen shot of an exemplary user interface for assigning users to user groups. In this embodiment, each of the active users is shown with a selection box next to each user. Adjacent to this listing is the selected user group, here the Pediatric Nursing Team 32. An administrator may select any number of users by indicating this within their selection box. Additionally, an administrator can ‘Select all’ users by indicating this within the ‘Select all’ box. The user interface may add the selected users to the user group through any number of actions, including but not limited to: the administrator may select a button or function for adding the selected users to the user group, the administrator may ‘drag and drop’ the selected users into the user group, or the administrator may choose the desired user or user group from a drop down menu. As shown here, the Pediatric Nursing Team 32 contains users 1, 2, and 3.

FIG. 6 is a screen shot of an exemplary user interface for assigning carts to cart groups. In this embodiment, each of the active carts are shown with a selection box next to each cart. Adjacent to this listing is the selected cart groups, here the Geriatric Carts 24 and the Pediatric Carts 22. An administrator may select any number of carts by indicating this within their selection box. Additionally, an administrator can ‘Select all’ carts by indicating this within the ‘Select all’ box. The user interface may add the selected carts to the cart group through any number of actions, including but not limited to: the administrator may select a button or function for adding the selected carts to the cart group or the administrator may ‘drag and drop’ the selected carts into the cart group. As shown here, the Geriatric Cart group 24 contains carts C, D, E, and F. Further, the Pediatric Cart group 22 contains carts A and B.

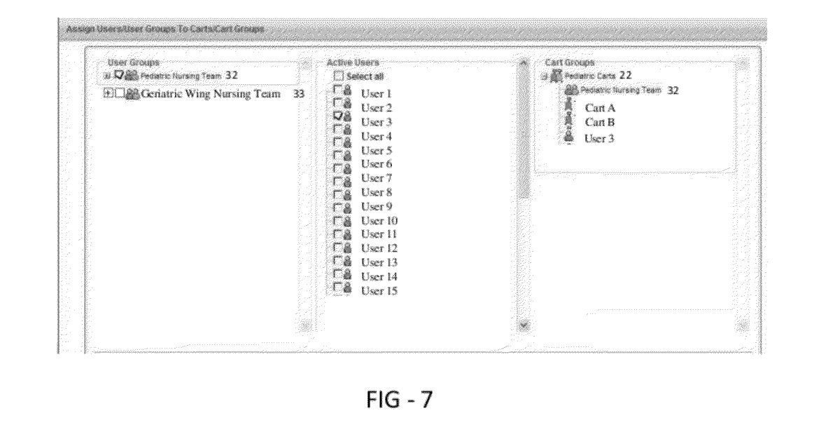

FIG. 7 is a screen shot of an exemplary user interface for assigning users, user groups, and carts to cart groups. In this embodiment, the available users and user groups are shown with a selection box next to each one. Similar to the previous pages, the desired user or user group may be selected by indicating this within their selection box. The selected cart group is also shown; here the selected cart group is the pediatric carts 22. As can be seen in this view, the pediatric cart group 22 contains carts A and B. Here, the pediatric nursing team 32 has been selected and given access to the pediatric cart group 22. In other words, by assigning the pediatric nursing team 32 to the pediatric carts 22, the identifying information for each user within the pediatric nursing team 32 has been stored as acceptable identifying information for any of the carts within the pediatric cart group 22. This allows many users to be given access to many carts in a single input into the system. Further, individual user 3 has been selected and given access to the pediatric cart group 22 (i.e. assigned to the cart group 22).

Again, the user interface may add the selected users and user groups to the cart group through any number of actions, including but not limited to: the administrator may select a button or function for adding the selected users or user groups to the cart group, the administrator may ‘drag and drop’ the selected users or user groups into the cart group, or the administrator may choose the desired user or user group from a drop down menu.

Once the appropriate users and user groups are added to each cart (either individually or through cart groups), the resulting data (user access data) may be sent to the carts (either at a pre-selected day and time or manually when the send changes 50 function is actuated from the home page).

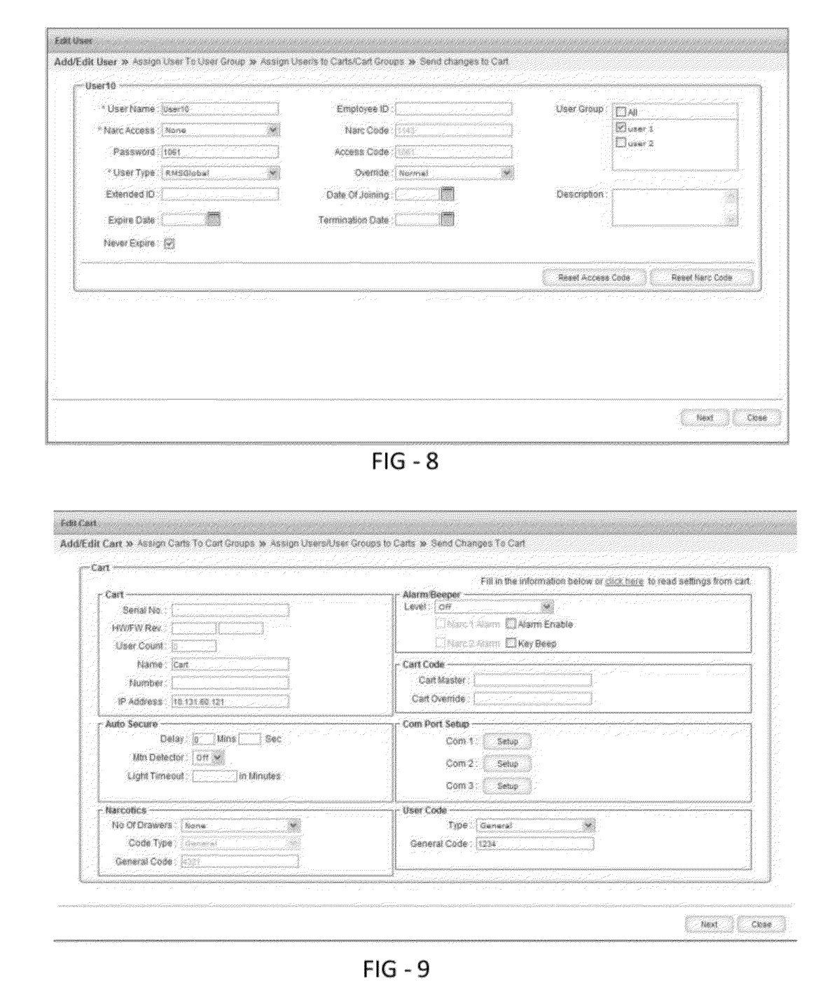

FIG. 8 is a screen shot of an exemplary user interface for editing user attributes and identifying information. As shown, a variety of attributes can be established and edited for each user including but not limited to: levels of access (i.e. narcotics), access expiration date, user type, employee ID, access codes/passwords, date joining/terminating, and assigned user groups. In some embodiments, the user interface may communication with the Active Directory database of employees in order to populate at least some of these fields automatically based on previously-stored data for the user. The user can be associated with unique identifying information so that when access to a cart is attempted, it can be determined if the user is in fact the person attempting to access the cart in question. The identifying information associated with the user can be encoded onto the user's access key (mechanical key number, RFID number, magnetic strip data, or fingerprint data) so that the cart may evaluate whether the person attempting to access the cart is authorized. If the user has been assigned to the cart (or a group that the cart is a member of) then the identifying information for that user is sent to and stored as acceptable at the cart. Further, if the user belongs to a group that has been assigned to the cart (or a group that the cart is a member of) then the identifying information for each user within that group is sent to and stored as acceptable at the cart. When the user attempts to access the cart, the identifying information presented by the user can be checked with the acceptable identifying information stored at the cart. If acceptable, the cart unlocks for access. If not acceptable, the cart remains locked. In either situation, the time/day (and further additional details) of the attempted access may be stored at the cart and later sent to the computing device for storage as a log for that particular cart.

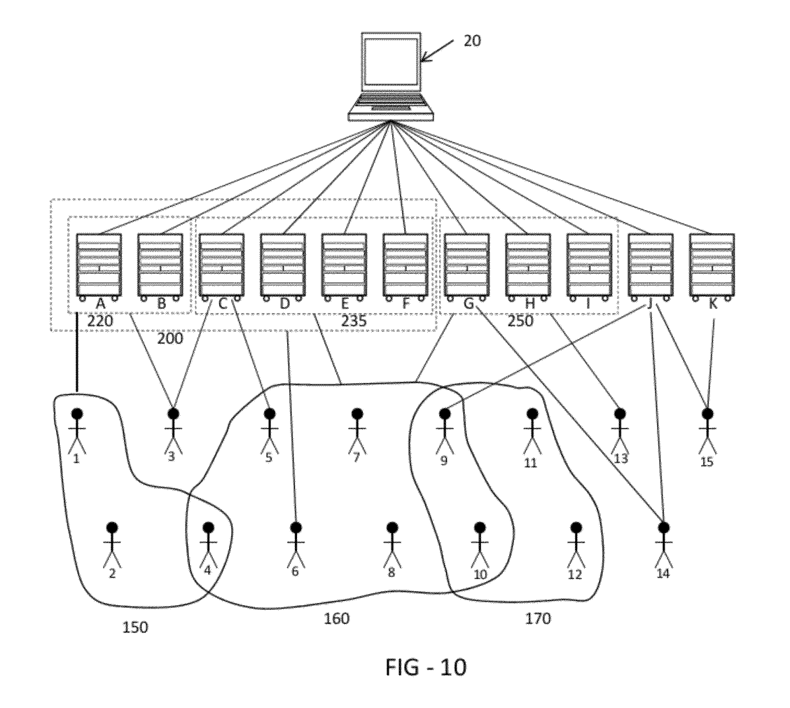

FIG. 9 is a screen shot of an exemplary user interface for editing cart attributes. As shown, a variety of attributes can be established an edited for each cart including but not limited to: serial number, hardware/firmware revision, associated user count, name of cart, number of cart, IP address of cart, settings for automatic locking/security (delay, motion detector settings, timeout settings), drawer types and access codes, alarm settings, communication port setup, and user codes. In some embodiments, some or all of this information may be automatically stored on the cart itself during manufacturing or setup process. This information may be contained within the local storage device on the cart. Thus, as shown in the figure, the user interface can allow the administrator to simply access this previously-stored information at the cart to populate various fields of data.

FIG. 10 is an illustration of another application for an exemplary embodiment of the invention. In this application, it is desirable for individual users and carts to be assigned to more than one user group or cart group. Thus, it is desirable for user 4 to be assigned to user group 150 and user group 160. Additionally, it is desirable for users 9 and 10 to be assigned to user group 160 and user group 170. In a similar manner, it is desirable for carts A and B to be assigned to cart group 220 and cart group 200. Further, it is desirable for carts C-F to be assigned to cart group 235 and cart group 200. This process of grouping and sub-grouping can be accomplished with the various embodiments herein, and can provide a significant benefit to the administrators of large and complicated medical facilities.

As can be appreciated, in some applications for larger businesses, there may be many different carts with hundreds of users. The access for each user may change regularly as well as the addition/deletion of users due to hiring/firing at the particular location. The embodiments herein permit large numbers of carts and users with complicated access provisions to be efficiently and securely maintained.

Having shown and described a preferred embodiment of the invention, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

We claim:

1. A computerized method for providing a user with access to selected carts by utilizing user groups, the method comprising the steps of:
accepting user group data for a first user group;
assigning a first cart entry to the first user group;
accepting identifying information for a user;
adding the identifying information for the user to the first user group to establish access for the user to the first selected cart, resulting in user access data;
storing the user access data at a computing device; and
transmitting the user access data to the first selected cart.

2. The method of claim 1 further comprising the steps of:
accepting user group data for a second user group;
assigning a second selected cart to the second user group; and
adding the identifying information for the user to the second user group to establish access for the user to the second selected cart.

3. The method of claim 1 wherein:
the computing device is a personal computer.

4. The method of claim 1 wherein:
the computing device is a server with a network connection.

5. The method of claim 1 wherein:
the transmitting step occurs over a wireless network.

6. The method of claim 1 further comprising the steps of:
locking the first selected cart;
accepting identifying information from a person attempting access to the first selected cart;
comparing the accepted identifying information with the identifying information for the user;
unlocking the cart if the accepted identifying information matches the user; and
remaining locked if the accepted identifying information does not match the user.

7. The method of claim 6 further comprising the steps of:
storing the date, time, and identifying information at the cart.

8. The method of claim 7 further comprising the steps of:
transmitting the stored date, time, and identifying information to the computing device.

9. A computerized method for managing access to a plurality of medical carts by utilizing cart groups, the method comprising the steps of:
accepting a plurality of cart entries;
accepting a first cart group;
assigning at least one of the plurality of cart entries to the first cart group;
accepting identifying information for a user;
adding the identifying information for the user to the first cart group to establish access for the user to all carts in the first cart group, resulting in user access data;
storing the user access data at a computing device; and
transmitting the user access data to the carts.

10. The method of claim 9 further comprising the steps of:
creating a second cart group;
adding at least one of the plurality of cart entries to the second cart group; and
adding the identifying information for the user to the second cart group to establish access for the user to all carts in the second cart group.

11. The method of claim 9 wherein:
the computing device is a personal computer.

12. The method of claim 9 wherein:
the computing device is a server with a network connection.

13. The method of claim 9 wherein:
the transmitting step occurs over a wireless network.

14. The method of claim 9 further comprising the steps of:
locking a cart that was added to the first cart group;
accepting identifying information from a person attempting access to the locked cart;
comparing the accepted identifying information with the identifying information for the user;
unlocking the cart if the accepted identifying information matches the user; and
remaining locked if the accepted identifying information does not match the user.

15. The method of claim 14 further comprising the steps of:
storing the date, time, and identifying information at the cart.

16. The method of claim 15 further comprising the steps of:
transmitting the stored date, time, and identifying information to the computing device.

17. A computerized method for managing access to a plurality of medical carts, the method comprising the steps of:
accepting unique identifying information for a plurality of users;
accepting a user group;
assigning at least one of the users to the user group;
accepting a plurality of cart entries;
accepting a cart group;
assigning at least one of the cart entries to the cart group;
assigning the user group to the cart group to establish access for each user in the user group to all carts in the cart group, resulting in user access data storing the user access data at a computing device; and
transmitting the user access data to the carts.

18. The method of claim 17 further comprising the steps of:
accepting identifying information from a person attempting access to one of the carts in the cart group;
comparing the accepted identifying information with the identifying information for the users in the user group;
unlocking the cart if the accepted identifying information matches any of the identifying information for a user in the user group; and
remaining locked if the accepted identifying information does not match any of the identifying information for a user in the user group.

19. The method of claim 18 further comprising the steps of:
storing the date, time, and identifying information at the cart.

20. The method of claim 19 further comprising the steps of:
transmitting the stored date, time, and identifying information to the computing device.
